(19) United States
(12) Patent Application Publication
(10) Pub. No.: US 2020/0266619 A1
(43) Pub. Date: Aug. 20, 2020

(54) Refrigeration And/Or Freezing Appliance

(71) Applicant: LIEBHERR-HAUSGERATE OCHSENHAUSEN GMBH, Ochsenhausen (DE)

(72) Inventors: Lars CIESLAK, Ulm (DE); Pascal OTTO, Ummendorf (DE)

(21) Appl. No.: 16/758,867

(22) PCT Filed: Oct. 23, 2018
(86) PCT No.: PCT/EP2018/079032

§ 371 Date: Apr. 24, 2020

(30) Foreign Application Priority Data
Oct. 26, 2017 (DE) 10 2017 125 169.3
Dec. 20, 2017 (DE) 10 2017 130 771.0

(51) Int. Cl. H02H 3/08; F25B 49/00; F25D 23/00; F25D 29/00; H02H 5/04; H02H 9/02

(52) U.S. Cl. CPC H02H 3/085; F25B 49/005; F25D 23/003; F25B 2700/21; H02H 5/043; H02H 9/02; F25B 2700/15; F25D 29/006

(57) ABSTRACT

An arrangement for a refrigerator and/or freezer comprising an electrical or electronic component (1, 2a), and comprising detection means (2, 4) by which an electrical or thermal load of the component can be detected, wherein the detection means comprise a heat source (2) and means for the detection (4) of the heat output of the heat source, wherein the heat source is not formed by the component itself and is connected in series or in parallel to the component.

The present invention relates to a refrigerator and/or freezer comprising an electrical or electronic component, and comprising detection means by which an electrical or thermal load of the component can be detected.

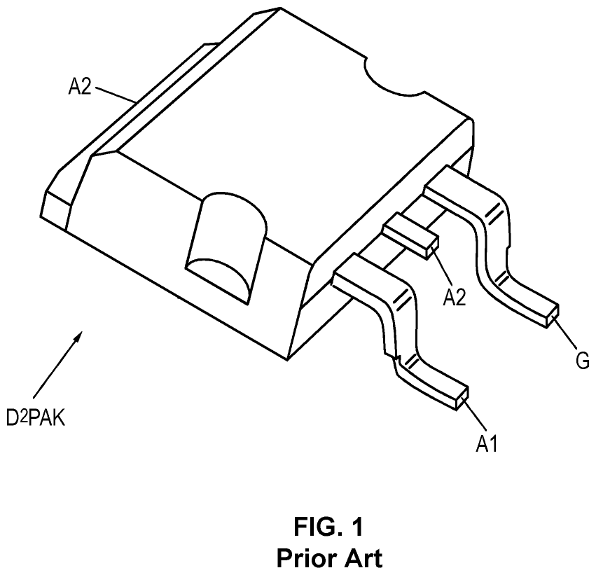

From the prior art it is known to arrange a temperature sensor close to the housing surface with the lowest heat transfer resistance to the heat source of a component. FIG. 1 shows a Triac, in which the housing surface with the lowest heat transfer resistance to the semiconductor directly is electrically connected to the terminal A2. As this terminal and hence its electrical potential depends on the switching condition of the Triac, a temperature measurement by means of a direct electrical connection between the sensor and the terminal A2 only is possible with a considerable amount of circuitry. For this reason, the sensor merely is arranged in local proximity to the Triac or is electrically and thermally connected to the terminal A1. The terminal A1 is exclusively connected to the semiconductor by bonding wires. Due to the unfavorable thermal connection, the temperature difference between the sensor and the component can be so great that an overload detection cannot be ensured in every case of application. Furthermore, a direct current measurement via a resistor at the terminal A1 is suitable for an overload detection. This current measurement, however, leads to an increased amount of circuitry and increased costs and does not allow to consider the ambient temperature and the thermal mass of the component.

Furthermore, components with an integrated temperature protection are known from the prior art, wherein these components are available only in a limited variety and are cost-intensive. Apart from this, they do not include the possibility to adapt the switch-off value.

From DE 10 2012 208 115 A1 a device for securing an electric line in a vehicle is known, in which the thermal properties of a conductor path are adapted to thermal properties of the electric line to be secured. The device comprises a temperature sensor which is designed to detect a temperature value of a conductor path that is electrically coupled to the electric line, and a delimitation unit which is designed to delimit a current flow through the electric line when the detected temperature value of the electric conductor path exceeds a predetermined value.

US 2011/0080681 A1 discloses a device for securing an electric line in a vehicle, wherein the device comprises a delimitation unit which is designed to reduce a current flow through the electric line when the detected temperature value exceeds a predetermined value. US 2008/0112131 A1 discloses a temperature sensor which is designed to detect the temperature value of a conductor path that is electrically coupled to an electric line.

It is disadvantageous in the prior art that the temperature of the component housing can be detected only very inaccurately so that the component cannot be operated close to its performance limit without running the risk of overloading the same.

It is the object underlying the present invention to provide a particularly precise possibility for detecting a load situation of an electrical or electronic component.

This object is solved by a refrigerator and/or freezer with the features of claim 1.

Accordingly, it is provided that the detection means comprise a heat source and means for detecting the heat output or the temperature of the heat source, wherein the heat source is not formed by the component itself and is connected in series or in parallel to the component.

Thus, the thermal or electric load or overload at the electric component is detected or prevented by using an additional heat source.

The same simulates the temperature or the temperature increase of the components in the event of a load or overload and preferably is configured such that at smaller currents in normal operation it merely reveals a low formation of heat, and at high loads the load situation of the component can be inferred from the temperature increase, the temperature and the heat output of the additional heat source.

The heat source can both be connected in series and in parallel to the component, wherein in the first case the heat output by the heat source among other things depends on the voltage difference across the component and in the second case among other things depends on the current flowing through the component.

The heat source can be connected upstream or downstream of the component to be monitored.

In one embodiment it is provided that the heat source is formed by a taper of a conductor path or a conductor. In this case, it is possible to infer the temperature of the component housing or a component. When the taper of the conductor path is arranged directly at or in the vicinity of the component housing or the component, it is possible to determine the temperature of the component in a particularly accurate way.

Alternatively, the heat source can be formed by an additional electrical or electronic component. For example, the heat source can be configured as an electrical resistor connected upstream or downstream of the component or connected in parallel. In each case, the output of heat is effected due to the Joule effect.

Furthermore, it can be provided that the heat source is not directly connected with the component, but is spaced apart from the same.

The invention also comprises the case that the means for detecting the heat output or temperature comprise a temperature sensor. Thus, the temperature of the heat source can be detected and then the temperature of the component can be inferred.

Alternatively or in addition, the means for detecting the heat output or the temperature can comprise an electrical or electronic component, in particular a temperature-dependent electrical resistor. However, the invention also comprises the case that the means for detecting the heat output or temperature comprise other electrical or electronic components, such as for example capacitive or inductive components whose electrical properties depend on the surrounding thermal conditions.

The means for detecting the heat output or the temperature can be in direct electrical connection with the heat source so that the measured heat output permits a more accurate conclusion as to the temperature of the component.

According to an advantageous embodiment of the invention, the means for detecting the heat output or the temperature are arranged such that by the same the ambient temperature of the appliance is detectable so that the same can automatically be taken into account upon detection of the load.

According to the invention, a protection circuit furthermore can be provided, which is connected with the detection means so that the load of the component is detected, wherein the protection circuit is configured such that the same reduces the load condition of the component in dependence on the detected load or the detected load condition of the component. It thereby is possible to protect the component against an electrical or thermal load and thereby prolong the service life of the component and lower the costs for its maintenance.

Preferably, the component to be monitored is disposed on a circuit board or conductor path.

At this point it should be noted that the term “a/an” not necessarily designates exactly one of the elements in question, although this represents a possible embodiment, but can also represent a plurality of the elements. The same applies for the use of the plural form, which can also comprise only one of the elements, and conversely for the use of the singular form, which can also designate several elements.

Further details and advantages of the invention will be explained in detail with reference to exemplary embodiments illustrated in the drawing, in which:

FIG. 1 shows the electrical construction of a Triac known from the prior art;

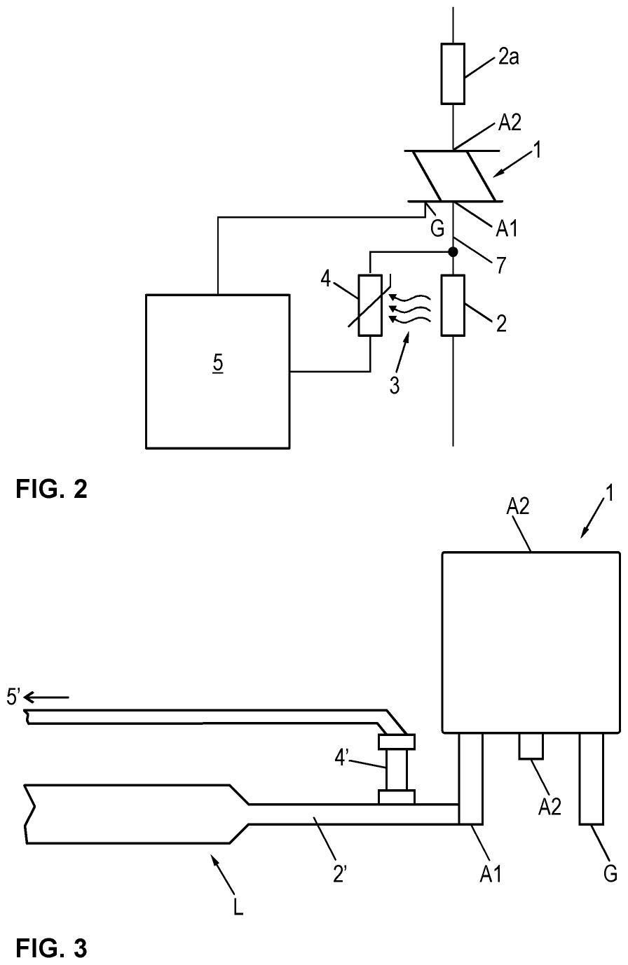

FIG. 2: shows an electronic component comprising a heat source which is formed by another electrical or electronic component;

FIG. 3: shows an electronic component comprising a heat source which is formed by a taper of the conductor path;

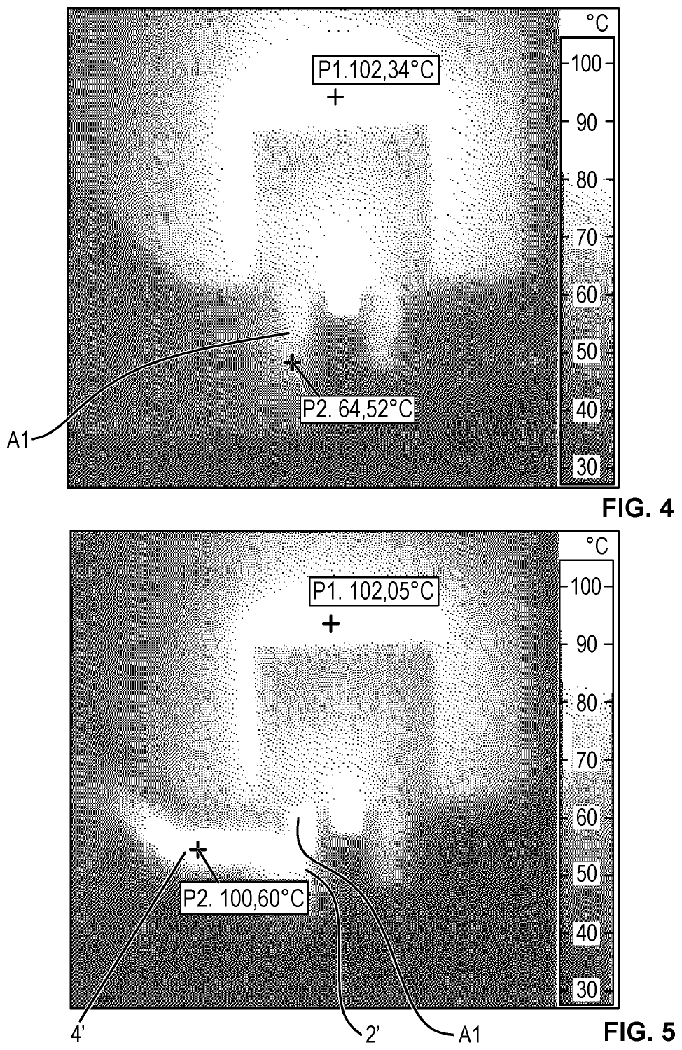

FIG. 4: shows the thermogram of the temperature difference between the housing and a terminal A1 in the case of a load or overload of a component known from the prior art;

FIG. 5: shows the thermogram of the temperature difference between the housing and the additional heat source in the case of a load or overload, wherein the additional heat source is formed by a taper of the conductor path.

FIG. 1 shows the electrical construction of a Triac known from the prior art. In this component, the temperature in the vicinity of the component or caused by an electrical and thermal connection is detected at the terminal A1, even if the housing surface with the lowest heat transfer resistance to the semiconductor directly is electrically connected to the terminal A2 so that the temperature detection at the terminal A2 would provide more precise results. The temperature detection at the terminal A2, however, only is possible with a considerable amount of circuitry, as this terminal and hence its electric potential are dependent on the switching condition of the component.

FIG. 2 shows an arrangement for a refrigerator and/or freezer according to the present invention, wherein the heat source is formed by another electrical or electronic component.

The means for detecting the heat output or the temperature are formed by a temperature-dependent resistor 4.

The electronic component 1 includes the terminals A1, A2 and G, which allow an electrical connection of the component 1. What is arranged in series in front of the terminal A1 is an electrical or electronic component 2 which due to the Joule effect converts the current flowing through the same into heat. In this case, the component 2 hence serves as a heat source.

By radiation and/or thermal conduction, which is designated by the arrows 3, the heat generated by the component 2 is transmitted to a temperature-dependent resistor 4 so that the same serves as a means for detecting the heat output or temperature of the heat source. The heat source 2 and the resistor 4 form the detection means.

This resistor 4 is electrically connected to the network branch 7 on the one hand and to a regulation and control unit 5 on the other hand. Consequently, the current flowing through the resistor 4 depends on the heat output by the component 2.

The regulation and control unit 5 comprises a protection circuit which is connected to the detection means, i.e. to the means 4 for detecting the heat output and to the heat source 2.

Thus, a possible overload of the component 1 can be prevented. The protection circuit of the regulation and control unit 5 is configured such that the same reduces the load condition of the component 1 in dependence on the detected load, when necessary, for example by limiting or completely switching off the current flowing to the component 1.

Reference numeral 2a symbolizes an electric load. The same can also be arranged at a greater distance to the switching element 1.

FIG. 3 shows an arrangement according to the invention, wherein the heat source is formed by a taper of the conductor path.

The component 1 shows the terminals A1, A2 and G, which allow an electrical connection of the component 1.

In particular, the terminal A1 is electrically connected to a conductor path L. Directly in front of the terminal A1, the conductor path L includes a taper 2′ which due to the reduced cross-section has a higher resistance.

The same causes an increased output of heat directly in front of the terminal A1, wherein the heat is thermally conductively detected by a temperature-dependent resistor 3′.

The taper 2′ in this case serves as the heat source and the temperature-dependent resistor 4′ serves as a means for detecting the heat output or temperature of the heat source. Together, they form the detection means.

The protection circuit 5′ can detect the warming of the additional heat source 2′ by means of the temperature-dependent resistor 4′ and react to a load situation or overload situation.

FIG. 4 shows the thermogram of the temperature differences between the housing and the terminal A1 in the case of a load or overload of a component known from the prior art. As can be taken from FIG. 4, there is a considerable difference between the temperatures measured at the terminal A1 and those measured at the housing of the component (about 28° C.) so that a precise determination of the load condition of the component is not possible.

FIG. 5 shows the thermogram of the temperature differences between the housing and the additional heat source in the case of a load or overload according to the invention, wherein the additional heat source is formed by a taper 2′ of the conductor path and the means for detecting the heat output are formed by a temperature-dependent resistor 4′.

In this case, the difference between the additional heat source thermally connected to the temperature-dependent resistor and the temperatures measured at the housing of the component only is about 1.45° C. so that a determination of the load condition can be effected more easily and precisely. It thereby is also possible to operate the component closer to its performance limit so that an improved utilization of the electrical or electronic component is possible.

1. A refrigerator and/or freezer comprising an electrical or electronic component, and comprising detection means by which an electrical or thermal load of the component can be detected, wherein the detection means comprise a heat source and means for detecting the heat output or the temperature of the heat source, wherein the heat source is not formed by the component itself and is connected in series or parallel to the component.

2. The refrigerator and/or freezer according to claim 1, wherein the heat source is provided upstream or downstream of the component.

3. The refrigerator and/or freezer according to claim 1, wherein the heat source is formed by a taper of a conductor path or a conductor.

4. The refrigerator and/or freezer according to claim 1, wherein the heat source is formed by an additional electrical or electronic component.

5. The refrigerator and/or freezer according to claim 1, wherein the heat source is not directly connected with the component.

6. The refrigerator and/or freezer according to claim 1, wherein the heat source is arranged locally separate from the component.

7. The refrigerator and/or freezer according to claim 1, wherein the means for detecting the heat output or the temperature comprise a temperature sensor.

8. The refrigerator and/or freezer according to claim 1, wherein the means for detecting the heat output or the temperature comprise an electrical or electronic component, in particular a temperature-dependent electrical resistor.

9. The refrigerator and/or freezer according to claim 1, wherein the means for detecting the heat output or the temperature are directly connected with the heat source.

10. The refrigerator and/or freezer according to claim 1, wherein the means for detecting the heat output or the temperature are arranged such that the ambient temperature of the appliance can be detected by the same.

11. The refrigerator and/or freezer according to claim 1, wherein a protection circuit furthermore is provided, which is connected to the detection means so that the load of the component is detected, wherein the protection circuit is configured such that the same reduces the load condition of the component in dependence on the detected load of the component.
